(19) United States
(12) Patent Application Publication
(10) Pub. No.: US 2020/0277127 A1
(43) Pub. Date: Sep. 3, 2020

(54) WHOLE-PRECUT INDIVIDUALLY-PACKAGED READY-TO-USE POMEGRANATE

(71) Applicant: THE STATE OF ISRAEL, MINISTRY OF AGRICULTURE & RURAL DEVELOPMENT, AGRICULTURAL RESEARCH ORGANIZATÍON, Rishon Lezion (IL)

(72) Inventors: Yakov VINOKUR, Rishon LeZion (IL); Victor RODOV, Petah Tikva (IL); Ron PORAT, Beit Dagan (IL); Batia HOREV, Rishon LeZion (IL)

(21) Appl. No.: 16/650,514

(22) PCT Filed: Sep. 27, 2018
(86) PCT No.: PCT/IL2018/051071

§ 371 Date: Mar. 25, 2020

Related U.S. Application Data
(60) Provisional application No. 62/564,358, filed on Sep. 28, 2017.

(51) Int. Cl. B65D 85/34; A23L 19/00

(52) U.S. Cl. CPC B65D 85/34; B65D 75/68; A23L 19/03

(57) ABSTRACT

A pomegranate serving and methods of providing same comprising
d. precut crushable ready-to-use single-piece pomegranate and
e. a flexible plastic liquid proof package (FPP) for containing said ready-to-use single-piece pomegranate
wherein the blossom end of said ready-to-use whole pomegranate is removed by a circular latitudinal peel cut exposing pulp, and the said ready-to-use whole pomegranate has a circular peel cut at the stem end and at least 3 longitudinal peel cuts for ease of manual crushing to express juice. The FPP is configured for gas exchange by microperforations and/or by protruding a synthetic or natural fiber cord loop through the sealed plastic seam and provided with an attached tearable member for opening said FPP.

### FIELD OF THE INVENTION

The invention relates to ready-to-use fruit products and more specifically to ready-to-use pomegranate fruit products.

### BACKGROUND OF THE INVENTION

Healthy properties of pomegranate are well-known and acknowledged by public, putting it into the category of “super-fruits” due to its health value confirmed by numerous studies.

However, pomegranate consumption is still limited due to the inconvenience of manual peeling and separation of the edible portion (arils, i.e. seeds with a juicy seed coat) and lack of optimal consumption method. In addition, while buying a whole pomegranate, a consumer cannot be sure about its internal quality, aril color and lack of internal disorders, discolorations, rots or damages that are not reflected by the external fruit appearance.

Limitations of consumption method do not allow full realization of the commercial potential of this crop.

The state-of-the art solutions aimed to facilitate the pomegranate consumption include:

Ready-to-eat separated arils. This product has short shelf-life due to the microbial contamination. The potential shelf life is claimed to be up to 12 days, but by that time the product has high microbial (predominantly yeast) counts resulting in deteriorated quality (off-flavors, juice leaching). This product has high cost due to either complicated machinery or extensive manual power needed for its preparation. Hard inedible seeds of many pomegranate cultivars hamper their consumption. The varieties with chewable seeds exist but they are vulnerable to mechanical damage during separation.

Commercially-prepared pomegranate juice encounters consumer's reluctance and suspicions due to unknown preparation procedure and origin, suspected adulteration, presence of additives and preservatives, unnatural taste in particular due to long storage, pasteurization and other manipulations. Individual home juice extraction demands special relatively costly equipment, is time-, space-, and labor-consuming for juicing and subsequent cleaning the equipment, and in addition results in a considerable amount of home waste.

The same operation performed in kiosks, convenience stores or groceries limits the consumption by availability of these processing points and their location. Its microbiological safety depends on local hygiene norms of the place and cannot be guaranteed because the hands of unknown and sometimes nonprofessional persons are involved in manual juicing, without any further product decontamination.

WO2003094680 relates to a packaging for a piece of fruit which comprises a blister part and a cover film that is hermetically connected to the blister part following positioning of a piece of fruit in the packaging. The blister part comprises a seed trap, in the form of protrusions and comprises a rupture indicator, whereby an opening in the hermetically closed packaging can be provided enabling fruit juice to be dispensed through the opening without it being blocked by fruit pulp or seeds. However, this article is not designed to preserve fruit quality during extended storage. It needs additional device (cup, glass, dish, etc.) for collecting the expressed juice and its consumption.

EP patent No. 2283735 discloses a fleshy, substantially round fruit, for instance a tomato, preprocessed for division into pieces suitable for consumption, provided with a number of incisions which extend in a cross-section radially from an imaginary center circle to the outer side of the fruit and which are distributed regularly over the cross-section, and method and device for preparing such a fruit However, the invention is intended for further manual separation of segments, not for juice squeezing. The flesh is cut and not only the peel.

U.S. Pat. No. 3,207,610 discloses individually packed citrus or the like fruit in ready to squeeze state, so that the consumer may extract its juice on merely squeezing the packed fruit in the manner accustomed for that purpose, thereby avoiding not only spoilage of a quantity of fruit from one or more rotten ones among them, but also all contact between a fruit and the hands serving and squeezing it in the best sanitary manner and with the least messiness. However, this method includes molding hot plasticized plastic polymer onto a fruit wedge with the aid of vacuum, and further vacuum packaging and vacuum storage of the product. These procedures can damage the fruit and result in migration of undesirable plastic ingredients into the edible fruit portion and the juice. The packaging does not allow gas exchange and does not provide optimal atmosphere for fruit respiration. Therefore, it is not suitable for extended storage of pre-cut pomegranates due to anaerobic taste deterioration. In addition, this solution is less hygienic and convenient for a consumer, especially for outdoors use, because it demands pouring the processed juice out of the package into a cup or a glass, and does not allow direct consumption of the expressed juice from the package. It lacks elements which would make direct consumption convenient.

U.S. Pat. No. 8,360,111 discloses a method for squeezing at least one fruit wedge, including providing at least one fruit wedge, providing a disposable funnel having substantially circular cross-section formed from a substantially stretchable material, the disposable funnel having an inlet and an outlet, inserting the fruit wedge through the inlet of the disposable funnel until the fruit wedge is substantially enclosed by the disposable funnel, providing a bottle having a neck, inserting the outlet of the disposable funnel into or stretching the disposable funnel over the neck of the bottle, squeezing the disposable funnel until juice separated from the fruit wedge is squirted through the outlet into the bottle and, squeezing the disposable funnel with sufficient force so that the fruit wedge is expelled from the funnel to substantially reside in the bottle. The device does not combine fruit storage and squeezing functions (serves only for squeezing).

None of the pomegranate consumption methods above allow full realization of the commercial potential of this crop.

It therefore remains a long felt and unmet need for a product and method for easy, clean, inexpensive, sustainable, preservative-free and consumer-friendly pomegranate consumption, that can be realized during a brief refreshment break in course of work or study, during recreation, during travel, at gas stations or highway recreation areas.

### SUMMARY OF THE INVENTION

An object of the present invention is to provide a pomegranate serving comprising
a. precut crushable ready-to-use single-piece pomegranate and
b. a flexible plastic liquid proof package (FPP) for containing said ready-to-use single-piece pomegranate
wherein the blossom end of said ready-to-use whole pomegranate is removed by a circular latitudinal peel cut exposing pulp, and the said ready-to-use whole pomegranate has a circular peel cut at the stem end and at least 3 longitudinal peel cuts for ease of manual crushing to express juice, said FPP is configured for gas exchange by microperforations and/or by protruding a synthetic or natural fiber cord loop through the sealed plastic seam and provided with an attached tearable member for opening said FPP. The pomegranate serving according to claim 1 wherein said ready-to-use pomegranate has at least one additional latitudinal peel cut.
A further object of the present invention provides the pomegranate serving wherein the stem end of said ready-to-use pomegranate is removed by a conical excision into the rind facilitating manual crushing and juice extraction. A further object of the present invention provides the pomegranate serving wherein said package is a shape selected from the group consisting of: bag-like, envelop-like, pouch-like, sleeve-like, sachet-like, funnel-like, irregular shaped or a combination thereof.
A further object of the present invention provides the pomegranate serving wherein said package is substantially transparent in at least a portion of same. A further object of the present invention provides the pomegranate serving wherein said package microperforation is configured to facilitate gas exchange through said package sufficient to prevent anaerobic fermentation and to provide a beneficial atmosphere composition of 5 to 18% carbon dioxide and 3 to 16% oxygen (the rest nitrogen) under conditions of storage at 4-12° C. for at least 18 d.
A further object of the present invention provides the pomegranate serving wherein the said package microperforation is achieved by protruding a synthetic or natural fiber cord loop through the sealed plastic seam.
A further object of the present invention provides the pomegranate serving wherein said package is provided with a perforated separator in the internal space of said package for filtering expressed juice from post crush pomegranate debris.
A further object of the present invention provides the pomegranate serving wherein a straw is installed within said package for facilitating juice consumption of said pomegranate.
A further object of the present invention provides the pomegranate serving wherein said FPP additionally comprises valve-type openings allowing unidirectional air release from said package space during squeezing.
A further object of the present invention provides the pomegranate serving wherein said FPP comprises a biodegradable or a compostable polymer material allowing a sustainable disposal of the squeezed pomegranate debris together with said package.
A further object of the present invention provides the pomegranate serving wherein juice yield is 30 to 60% of the pomegranate weight.
A further object of the present invention provides the pomegranate serving wherein the microbial load in the juice expressed from said serving after 12 days of storage at 8° C. is at least 1 log CFU/g lower than in the juice expressed from a serving of separated arils prepared from the same batch of fruit and stored under the same conditions.
A further object of the present invention provides the pomegranate serving wherein the microbial load after the storage period of 2.5 weeks at 8° C. is below 7 log CFU/g.
A further object of the present invention provides the pomegranate serving wherein the phenolics content in the juice expressed from said serving is higher than in the juice expressed from a serving of separated arils prepared from the same batch of fruit and stored under the same conditions.
A further object of the present invention provides the pomegranate serving wherein the phenolics content in the juice expressed from said serving is 0.5-6.0 mg GAE/g.
A further object of the present invention discloses a method of providing a pomegranate serving comprising steps of
a. providing a precut crushable ready-to-use whole pomegranate
   wherein the blossom end of said ready-to-use whole pomegranate is removed by a circular latitudinal peel cut exposing pulp, and the said ready-to-use whole pomegranate has a circular peel cut at the stem end and at least 3 longitudinal peel cuts for ease of manual crushing to express juice, and
b. providing a flexible plastic liquid proof package (FPP) for containing said ready-to-eat whole pomegranate
   wherein said FPP is configured for gas exchange by microperforations and/or by protruding a synthetic or natural fiber cord loop through the sealed plastic seam and provided with an attached tearable member for opening said FPP, and
c. inserting said precut crushable ready-to-use whole pomegranate into said flexible plastic liquid proof package (FPP).

### BRIEF DESCRIPTION OF THE DRAWINGS

In the following description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

In the accompanying drawings:

FIG. 1 illustrates the stages of preparation of the whole-precut pomegranates of the present invention; a—removal of a stem-end by conical incision; b—removal of a blossom end by latitudinal cut; c—a whole-precut pomegranate of the present invention with removed stem- and blossom ends and exposed arils; d—longitudinal and latitudinal cuts of the pomegranate peel;

FIG. 2 illustrates individually packaged whole-precut pomegranate of the present invention;

FIG. 3 illustrates the squeezing method of the whole-precut pomegranate of the present invention;

FIG. 4 illustrates the juice separation from the fruit debris and opening the package by ripping the cord loop; and,

FIG. 5 illustrates the juice evacuation/consumption by straw sipping of the present invention.

FIG. 6 presents a graph of the microbiological quality vs storage period of the present invention;

FIG. 7 presents a graph of the juice yield vs. storage period of the present invention;

FIG. 8 presents a graph of the off-flavors of the present invention;

FIG. 9 presents a graph of the content of phenolic compounds vs. storage period (a) and vs. perforation level (b) of the present invention.

### DETAILED DESCRIPTION OF THE PREFERRED EMBODIMENTS

“blossom end”: part of a pomegranate fruit bearing a persistent calyx containing a stamen cluster;

“stem end”: part of a fruit originally attached to a stem, bearing a stem scar or a pedicel residue, usually located opposite blossom end;

“whole pomegranate”: a pomegranate that retains the integrity of its edible portion (flesh or Pulp) as a single piece in contrast to separated arils . . . so that partially or even completely peeled fruit is still “whole” once it hasn't been broken into pieces, but a fruit wedge is not};

“whole-precut”: a fruit that retains the integrity of its edible portion [flesh] as a single piece but its peel is precut in a way that facilitates processing and consumption;

“peel cut”: a cut, or a score or an incision through the rind and albedo that does not wound the flesh;

“flesh” (“pulp”) {and/or “edible portion”; the difference is that “edible portion” comprises only the plurality of arils while “flesh” includes also white membranes <and other inedible parts of the flesh> but maybe we should just choose one of these terms e.g. “flesh” and use it consistently for a whole fruit and “arils” when they have been separated from the peel and the membranes}

The present invention has been defined specifically to provide article of manufacture, product and methods for packaging, producing and consuming juice from a pomegranate.

The product comprises a single-piece pomegranate fruit precut in a manner that exposes part of its attractive flesh (arils) and allows further manual juice squeezing, and a multifunctional packaging for storage, marketing, processing and consumption of the fruit. The packaging is flexible such that pomegranate juice can be squeezed out of the pomegranate while it is contained in the packaging which further comprises means for immediate consumption of the pomegranate. A drinking straw is provided for consumption of the expressed juice.

The core of the present invention is a novel method and means of pomegranate consumption that comprising the following steps: precutting; packaging; distribution/storage/marketing; crushing by a consumer prior to consumption; consumption of the freshly-squeezed juice directly from the package. The form of single-piece whole-precut pomegranate keeps most of the peel that protects the tender and fragile arils and ensures better shelf life and keeping quality than in separated arils; at the same time removal of the blossom end exposes to the consumer part of the attractively looking arils, and precutting facilitates manual crushing and juicing. The package facilitates (a) storage by creating optimal atmosphere, (b) marketing by exposing the arils to a customer, (c) processing by allowing in-package crushing and separating the juice from fruit debris, (d) consumption by providing a juice container and a retractable straw. All these operations are performed inside the same multifunctional package. The consumer gets the fruit in the most convenient and hygienic form of a freshly-squeezed juice without a need to spit or to chew and swallow pomegranate seeds.

Reference is now made to a pomegranate serving comprising
a. a precut crushable ready-to-consume single-piece pomegranate and
b. a flexible plastic liquid proof package (FPP) for containing said ready-to-eat whole pomegranate

The blossom end of the said ready-to-use whole pomegranate is removed by a circular latitudinal peel cut exposing pulp, and the said ready-to-use whole pomegranate has a circular peel cut at the stem end and at least 3 longitudinal peel cuts for ease of manual crushing to express juice. The FPP is configured for gas exchange by microperforations and/or by protruding a synthetic or natural fiber cord loop through the sealed plastic seam of the FPP. in order to crush the fruit it may be sufficient to make a circular cut {e.g. by a cork-borer} at the stem end and not necessarily to excise it. Conical excision is also a kind of “circular cut” and is presented as an option in a further paragraph].

The FPP is further provided with an attached tearable member for opening the FPP.

Reference is now made to the above mentioned pomegranate serving wherein the ready-to-use pomegranate has at least one latitudinal peel cut.

Reference is now made to the above mentioned pomegranate serving wherein the stem end of the said ready-to-use pomegranate is removed by a conical excision into the rind facilitating manual crushing and juice extraction.

Reference is now made to the above mentioned pomegranate serving wherein said package is a shape selected from the group consisting of: bag-like, envelope-like, pouch-like, sleeve-like, sachet-like, funnel-like, irregular shape or a combination thereof.

Reference is now made to the above mentioned pomegranate serving wherein said package is substantially transparent in at least a portion of same.

Reference is now made to the above mentioned pomegranate serving wherein said package microperforation is configured to facilitate gas exchange through said package sufficient to prevent anaerobic fermentation and to provide a beneficial atmosphere composition of 5 to 18% carbon dioxide and 3 to 16% oxygen (the rest nitrogen) under conditions of storage at 4-12° C., for at least 18 days. in some embodiments, a range of microperforations number, 1 to 20 microperforations of 50 to 150 micrometers in diameter per package, is provided for “regular” microperfoorations for gas exchange. In some non limiting embodiments of the invention a cord microperforation uses a “loop” [i.e. a ring-shaped article] meaning that there are two cords protruding through the seam. In some embodiments of the invention the diameter of the cord is 1 to 3 mm Gas exchange may occur through a protruded cord:

Reference is now made to the above mentioned pomegranate serving wherein said package is provided with a perforated separator or sieve in the internal space of said package for filtering expressed juice from post crush pomegranate debris

Reference is now made to the above mentioned pomegranate serving wherein a straw is installed within said package for facilitating juice consumption of said pomegranate.

Reference is now made to the above mentioned pomegranate serving wherein said FPP additionally comprises valve-type openings allowing unidirectional air release from said package space during squeezing.

Reference is now made to the above mentioned pomegranate serving wherein said FPP is a biodegradable or a compostable polymer material allowing a sustainable disposal of the squeezed pomegranate debris together with said package.

Reference is now made to the above mentioned pomegranate serving wherein juice yield is 30 to 60% of the pomegranate weight.

Reference is now made to the above mentioned pomegranate serving wherein the microbial load after 12 days of storage at 8° C. is about 3 log CFU/g lower than in the serving of separated arils prepared from the same batch of fruit and stored under the same conditions. The aforementioned data are provided as an example, since the microbial load depends on many factors.

Reference is now made to the above mentioned pomegranate serving wherein after the storage of 2.5 weeks at 4 to 12° C. the microbial load does not exceed 7 log CFU/g.

Reference is now made to the above mentioned pomegranate serving wherein the juice expressed from the whole cut pomegranate has a total phenolics content of 0.5 to 6.0 mg GAE/mL. These data are provided as an example and the exact content depends on the cultivar and cannot be guaranteed, but in any case the phenolics content is within an acceptable amount for consumption of the pomegranate juice.

Reference is now made to a method of providing a pomegranate serving comprising steps of providing
i. a precut crushable ready-to-use single piece pomegranate and
ii. a flexible plastic liquid proof package (FPP) for containing said ready-to-use whole pomegranate
wherein the blossom end of the said ready-to-use whole pomegranate is removed by a circular latitudinal peel cut exposing pulp, and the said ready-to-use whole pomegranate has a circular peel cut at the stem end and at least 3 longitudinal peel cuts for ease of manual crushing to express juice, said FPP is configured for gas exchange by microperforations and/or by a protruding synthetic or natural fiber cord loop through the sealed plastic seam and provided with an attached tearable member for opening said FPP, and
c. inserting said precut crushable ready-to-use whole pomegranate into said flexible plastic liquid proof package (FPP)

The present invention provides an article of manufacture for facilitating pomegranate consumption, comprising: a microperforated flexible plastic package (MFPP) [MFPP?] with a tearable portion for enclosing one pomegranate portion and a cord loop interconnected to the MFPP. The cord loop comprises a section attached to the tearable portion of said package and a pullable end for tearing said portion open. The package may be in a shape selected from the group consisting of: bag, envelope-like, pouch-like, sleeve-like, funnel-like and a combination thereof.

The package may be a biodegradable or a compostable polymer material allowing a sustainable disposal of the squeezed pomegranate debris together with the article. In another embodiment the article is made of a material with an improved visibility of the pomegranate and content thereof.

The present invention further provides a pomegranate in a microperforated flexible plastic package wherein the MFPP comprising: a tearable portion and a cord loop attached to said tearable portion at one section and a pullable end for tearing said portion open.

The present invention further provides a beverage produced by the article of manufacture.

The article allows visualization of the pomegranate attractive pulp and facilitating its manual squeezing by a consumer for immediate consumption of freshly-squeezed juice, and individually enclosed in a sealed microperforated flexible plastic package. The pomegranate preparation comprises adequate surface decontamination followed by removing part of the peel by circular peel cut In some embodiments of the invention “Conical excision” relates to the removal of stem-end (when it is completely removed), not the blossom end; removal of the blossom end is done by a circular peel cut] at a blossom-end side exposing a limited area of arils [flesh?], and making a series of latitudinal and longitudinal peel cuts. The article performs several functions; (a) attracting the attention of potential consumers by exposing the peeled flesh area through a transparent window, (b) serving a storage container preserving the precut crushable ready-to-consume whole pomegranate and allowing its extended storage due to the modified atmosphere generated, (c) serving a processing container for clean manual squeezing of the precut pomegranate and (d) serving a consumption container for immediate consumption of the freshly squeezed juice directly from it without pouring into a glass or cup or sprinkling on foods—as in other similar inventions

Specified optimal microperforation level allows gas exchange through the packaging material, preventing anaerobic fermentation and allowing the formation of optimal modified atmosphere for pomegranate quality preservation.

The gas exchanged may be performed by protruding an appropriate synthetic or natural fiber cord loop through the sealed plastic article seam.

The cord loop is configured for pulling, thereby opening the article.

In some embodiments of the invention the cord loop is configured as a gas exchange wick and partially protrudes from the FPP.

The expressed juice can be separated from the smashed pomegranate debris by a perforated separator installed in the internal space of the article.

The juice evacuation/consumption may be performed by sipping using a retractable straw installed in the article, without the need in additional cup or glass. Alternatively, the juice may be consumed after pouring the juice into a cup or a glass through the opening formed after ripping the cord loop.

Optionally, the article may be additionally amended with valve-type openings allowing unidirectional air release from the article space during squeezing for equilibrating the internal air pressure during the manual squeezing.

A concept solution for designing a mechanical device for precutting the pomegranate into a desirable form has been elaborated.

The article may be prepared from biodegradable or compostable polymer material allowing a sustainable disposal of the squeezed pomegranate debris together with the used article.

In another embodiment of the present invention, the article may be a disposable package.

In another embodiment of the present invention, the article has an extended storage life.

The present invention further provides a method of making a pomegranate beverage comprising the steps of:

providing an article of manufacture for facilitating pomegranate consumption, comprising: a microperforated flexible plastic package with a tearable portion for enclosing at least one pomegranate portion; and a cord loop interconnected to said microperforated flexible plastic package;

placing a whole cut pomegranate within said package;

sealing said package;

squeezing said pomegranate manually within said sealed package; and tearing and pulling at least one section of said cord loop for opening said for juice immediate consumption.

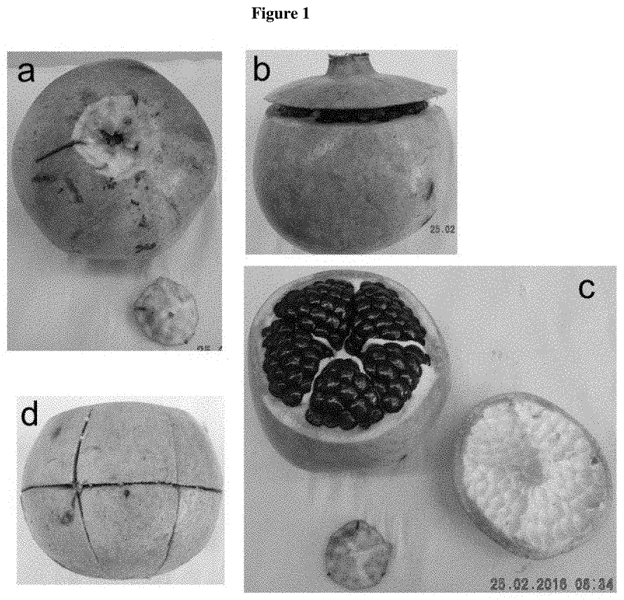

Reference is now made to FIG. 1 which illustrates the whole-precut stages of preparation of the whole-precut pomegranates of the present invention; a—removal of a stem-end by conical excision; b—removal of a blossom end by latitudinal peel cut; c—a whole-precut pomegranate of the present invention with removed stem- and blossom ends and exposed arils; d—longitudinal and latitudinal peel cuts of the pomegranate;

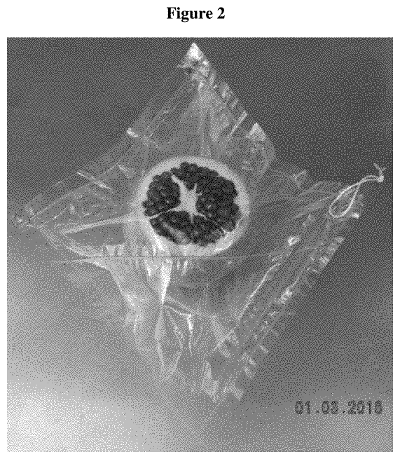

Reference is now made to FIG. 2 which illustrates individually packaged whole-precut pomegranate.

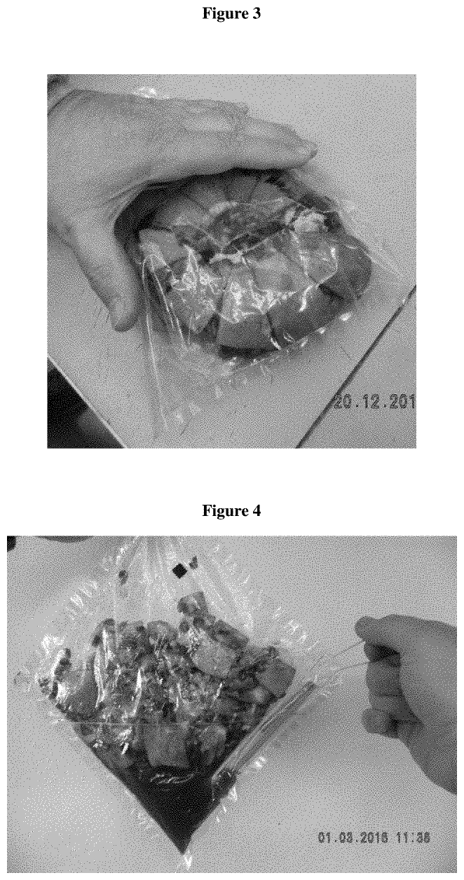

Reference is now made to FIG. 3 which illustrates the manner of manually squeezing or crushing the whole-precut pomegranate.

Reference is now made to FIG. 4 which illustrates juice separation from crushed fruit debris and opening the squeezed article by ripping the cord loop.

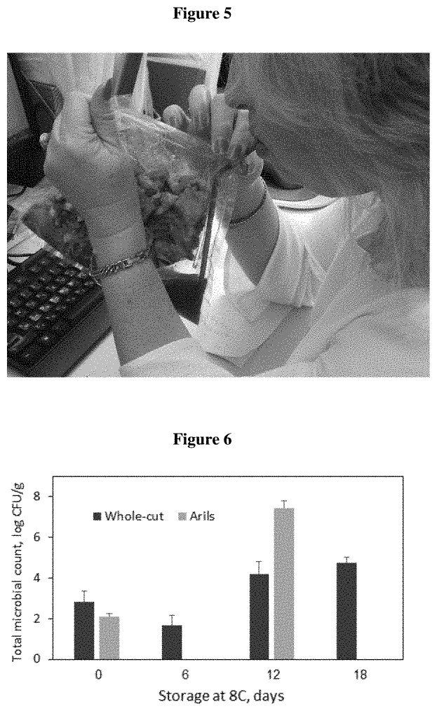

Reference is now made to FIG. 5 which illustrates juice evacuation/consumption by straw sipping.

Reference is now made to FIG. 6 which presents a graph of the Microbiological quality of the juice expressed from whole-precut pomegranate and from separated arils stored in FPP with 4 microperforations/package.

After 12 days of storage, the microbial load on the separated arils exceeded 7 log CFU/g—an acceptability threshold for ready-to-eat products. At the same time, the microbial load on the whole-precut product was about 3 log (1000 times) lower than in the separated arils. The storage of the whole-precut product could be extended for at least 6 additional days without a significant increase in microbial load.

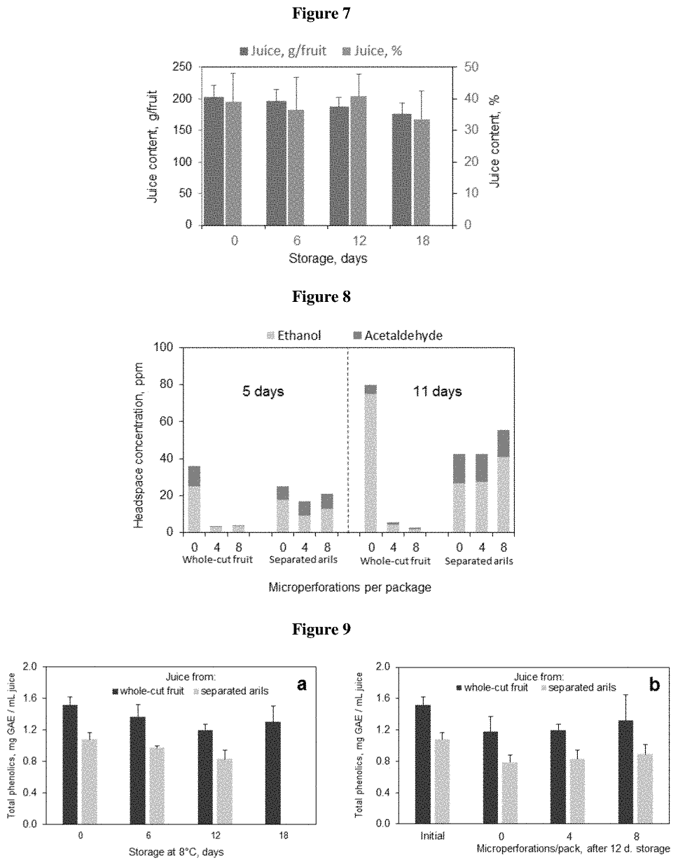

Reference is now made to FIG. 7 which presents a graph of the juice yield vs. storage days.

The juice yield was 35-40% of the fresh pomegranate weight and did not change significantly during 18 days of storage. [The juice yield may vary greatly depending on cultivar and fruit maturity. The values are presented just as an illustration.]

4

Reference is now made to FIG. 8 which presents a graph of the headspace concentrations (ppm) of ethanol and acetaldehyde vapors associated with fermented off-flavor, vs. product type, microperforations number and storage duration.

In accordance of the present invention, the negligible amount of off-flavor-associated volatiles was produced by the whole-precut fruit kept in microperforated articles. Storage in non-perforated articles resulted in off-flavor generation due to the oxygen depletion causing the anaerobic fermentation. Separated arils produced high amount of off-flavor volatiles irrespectively of the perforation level, due to the yeast contamination.

Reference is now made to FIG. 9 which presents a graph of the total phenolics content (mg GAE/g fr. weight) in the juice expressed from whole-precut pomegranate and from the separated arils stored at 8° C., vs. storage duration in FPP with 4 microperforations per article (a) and vs. microperforations number per FPP before storage (“Initial”) and after 12 days of storage.

Juice extracted from the whole-precut fruit contained higher amount of phenolic compounds indicating higher health value than the juice extracted from the separated arils. The enhanced level of phenolics was due to the peel presence during extraction but did not result in unacceptable astringency or bitterness of the juice. The juice had typical pomegranate flavor and attractive dark-red color.

As illustrated, the effects of storage duration and microperforation level on the phenolics content of whole cut pomegranate were minor and in most cases statistically insignificant.

1. A pomegranate serving comprising
a. precut crushable ready-to-use single-piece pomegranate and
b. a flexible plastic liquid proof package (FPP) for containing said ready-to-use single-piece pomegranate
wherein the blossom end of said ready-to-use whole pomegranate is removed by a circular latitudinal peel cut exposing pulp, and the said ready-to-use whole pomegranate has a circular peel cut at the stem end and at least 3 longitudinal peel cuts for ease of manual crushing to express juice, said FPP is configured for gas exchange by microperforations and/or by protruding a synthetic or natural fiber cord loop through the sealed plastic seam and provided with an attached tearable member for opening said FPP.

2. The pomegranate serving according to claim 1 wherein said ready-to-use pomegranate has at least one additional latitudinal peel cut.

3. The pomegranate serving according to claim 1 wherein the stem end of said ready-to-use pomegranate is removed by a conical excision into the rind facilitating manual crushing and juice extraction.

4. The pomegranate serving according to claim 1, wherein said package is a shape selected from the group consisting of: bag-like, envelop-like, pouch-like, sleeve-like, sachet-like, funnel-like, irregular shaped or a combination thereof.

5. The pomegranate serving according to claim 1, wherein said package is substantially transparent in at least a portion of same.

6. The pomegranate serving according to claim 1, wherein said package microperforation is configured to facilitate gas exchange through said package sufficient to prevent anaerobic fermentation and to provide a beneficial atmosphere composition of 5 to 18% carbon dioxide and 3 to 16% oxygen (the rest nitrogen) under conditions of storage at 4-12° C. for at least 18 d.

7. The pomegranate serving according to claim 1 wherein the said package microperforation is achieved by protruding a synthetic or natural fiber cord loop through the sealed plastic seam.

8. The pomegranate serving according to claim 1, wherein said package is provided with a perforated separator in the internal space of said package for filtering expressed juice from post crush pomegranate debris.

9. The pomegranate serving according to claim 1, wherein a straw is installed within said package for facilitating juice consumption of said pomegranate.

10. The pomegranate serving according to claim 1, wherein said FPP additionally comprises valve-type openings allowing unidirectional air release from said package space during squeezing.

11. The pomegranate serving according to claim 1, wherein said FPP comprises a biodegradable or a compostable polymer material allowing a sustainable disposal of the squeezed pomegranate debris together with said package.

12. The pomegranate serving according to claim 1, wherein juice yield is 30 to 60% of the pomegranate weight.

13. The pomegranate serving according to claim 1, wherein the microbial load in the juice expressed from said serving after 12 days of storage at 8° C. is at least 1 log CFU/g lower than in the juice expressed from a serving of separated arils prepared from the same batch of fruit and stored under the same conditions.

14. The pomegranate serving according to claim 1, wherein the microbial load after the storage period of 2.5 weeks at 8° C. is below 7 log CFU/g.

15. The pomegranate serving according to claim 1, wherein the phenolics content in the juice expressed from said serving is higher than in the juice expressed from a serving of separated arils prepared from the same batch of fruit and stored under the same conditions.

16. The pomegranate serving according to claim 1, wherein the phenolics content in the juice expressed from said serving is 0.5-6.0 mg GAE/g.

17. A method of providing a pomegranate serving comprising steps of
a. providing a precut crushable ready-to-use whole pomegranate wherein the blossom end of said ready-to-use whole pomegranate is removed by a circular latitudinal peel cut exposing pulp, and the said ready-to-use whole pomegranate has a circular peel cut at the stem end and at least 3 longitudinal peel cuts for ease of manual crushing to express juice, and
b. providing a flexible plastic liquid proof package (FPP) for containing said ready-to-eat whole pomegranate
wherein said FPP is configured for gas exchange by microperforations and/or by protruding a synthetic or natural fiber cord loop through the sealed plastic seam and provided with an attached tearable member for opening said FPP, and
c. inserting said precut crushable ready-to-use whole pomegranate into said flexible plastic liquid proof package (FPP).
